(19) United States
(12) Patent Application Publication
(10) Pub. No.: US 2012/0166344 A1
(43) Pub. Date: Jun. 28, 2012

(54) SECURE WIRELESS PAYMENT SYSTEM AND METHOD THEREOF

(75) Inventors: Chen-Mou Cheng, Taipei City (TW); Li-Ho Yao, Taipei (TW)

(73) Assignee: Li-Ho YAO, Taipei (TW)

(21) Appl. No.: 13/087,569

(22) Filed: Apr. 15, 2011

(30) Foreign Application Priority Data
Dec. 28, 2010 (TW) 099146753

(51) Int. Cl. G06Q 20/00; H04L 9/28

(52) U.S. Cl. 705/75; 705/44

(57) ABSTRACT

A secure wireless payment system and method thereof allow a consumer to acquire transaction information generated by a payment requesting unit of a seller with a handheld payment responding unit. The payment responding unit has a storage unit embedded with payment authentication data. After the consumer confirms that the transaction information is correct, a payment request is generated and transmitted to a banking unit releasing the payment authentication data through a secure wireless voice channel so that the banking unit can directly approve to pay. Accordingly, consumers need not present credit cards for sellers to charge and fully eliminate the risk of credit card piracy. Additionally, the payment responding unit of the present invention can be automatically connected with the banking unit releasing the payment authentication data for payment of a transaction.

### BACKGROUND OF THE INVENTION

1. Field of the Invention

The present invention relates to a secure transaction system, and more particularly to a secure wireless payment system and method thereof.

2. Description of the Related Art

The prevailing plastic money or credit cards have brought revolution to consumers' payment habit for its convenient and easy way to pay. More and more transactions tend to be paid by plastic money, especially when a large payment is involved.

The benefits of the plastic money also draw some greedy eyes to commit a crime by stealing credit card users' personal information by taking advantage of information security vulnerability in a transaction process using the plastic money, and credit card piracy causes individual consumer or bank to suffer from the financial loss in particular among all the relevant crimes.

Credit card payment systems have been available for years. With reference to FIG. 5, after a store applies for getting a credit card reader 61, a secure connection can be established between the credit card reader 61 and an issuing bank 50 through a secure network, and a credit card 60 provided by a consumer can be charged through the credit card reader 61. The billing process is performed as follows. After the store accepts the credit card 61 provided by the consumer, the credit card is swiped through the credit card reader 60, and the credit card reader 60 automatically connects to the issuing bank 50. A worker in the store presses down the buttons of the credit card reader 60 to enter the amount of the transaction. The issuing bank verifies if the credit card number is correct in accordance with the credit card number transmitted by the credit card reader 60, approves the amount of charge if the credit card is verified, and sends back an authorization code to the credit card reader 60 for printing out an authorization slip. After confirming the payment amount on the authorization slip, the consumer signs the slip in completion of the billing process. However, for such a credit card payment system, people with bad intention easily attach a key logger to the credit card reader to directly access credit card information to commit credit card piracy when a credit card is being charged on.

To lower the chance of theft of personal information associated with credit cards, many related professionals address different credit card payment systems, such as the example disclosed in U.S. Pat. No. 7,292,996 B2. With reference to FIG. 6, a credit card payment method is disclosed by the US patent and is applied between a consumer's mobile phone and a point of sale (POS) machine conducting a transaction with the consumer. The method has steps of:

providing a transaction platform 70 composed of one or multiple computer systems;

storing personal information of consumers including credit card numbers;

receiving a transaction request transmitted from a remote POS machine 74;

transmitting transaction information to the consumer's mobile phone 73;

confirming the authenticity of the transaction information through the mobile phone 73;

receiving a personal authentication code from the mobile phone 73 through a wireless communication network;

authenticating the consumer's identity in accordance with the received personal authentication code and the pre-stored personal information;

after confirming that the mobile phone 73 is adjacent to the POS machine 74, generating a payment request having the transaction information and the credit card number;

after a transaction receiving unit 71 receives the payment request, executing a payment approval procedure through a secure network 72;

after the payment request is approved, transmitting the authenticated transaction information from the transaction receiving unit 71 to the transaction platform 70;

transmitting a transaction confirmation message from the transaction platform 70 to the mobile phone 73 to show the message to the consumer; and

transmitting an authentication message from the transaction receiving unit 71 to the POS machine 74 to print out a receipt.

The US patent adds the transaction platform 70 and the transaction receiving unit 71 within a trusted zone instead of in a public network to respectively communicate with the consumer's mobile phone 73 and the POS machine 74. After receiving the transaction request transmitted from the POS machine 74, the transaction receiving unit 71 informs the transaction platform 70. After the transaction platform 70 and the consumer's mobile phone 73 jointly authenticate the identity of the consumer, and the consumer confirms the transaction, the transaction receiving unit 71 further approves the payment procedure in accordance with the stored credit card number of the consumer through the secure network 72.

To enhance transaction security of existing credit card payment systems, the above US patent must be additionally equipped with the transaction platform 70 and the transaction receiving unit 71. Credit card related personal information is stored in the transaction platform 70 so that credit card information is transmitted only in the trusted zone, and consumers can finish payment without presenting credit cards. However, the transaction receiving unit 71 and the transaction platform are mounted outside secure networks of the issuing banks, and the transaction platform 70 must be stored with personal credit card information of consumers. Besides, the transaction receiving unit 71 must be connected with the POS machine 74. The initial connection scheme between the POS machine 74 and the issuing bank needs to be changed. The implementation of the entire system is complicated.

### SUMMARY OF THE INVENTION

An objective of the present invention is to provide a secure wireless payment system and method thereof, not only effectively preventing insecure credit card piracy but also lowering the system cost relative to those of conventional credit card payment systems.

To achieve the foregoing objective, the secure wireless payment system has a banking unit, a payment requesting unit and a payment responding unit.

The banking unit is connected with a wireless voice communication unit, and is stored with payment authentication data.

The payment requesting unit has a transaction information generation device and a first near-field communication device, and is connected with the banking unit through a secure network.

The payment responding unit has a data processor, a storage unit, a second near-field communication device and a wireless voice communication module. The data processor is electrically connected with the storage unit and the second near-field communication device, is locally and wirelessly connected with the first near-field communication device of the payment requesting unit through the second near-field communication device to receive transaction information transmitted from the payment requesting unit, generates a payment request according to the transaction information and a corresponding payment authentication datum, loads the payment request in a wireless voice channel via the wireless voice communication module, and transmits the payment request to the banking unit through the wireless voice communication unit to acquire a payment authorization and complete a payment.

To achieve the foregoing objective, the secure wireless payment method is executed among a payment requesting party, a payment responding unit and a banking unit, and has steps of:

establishing a local wireless connection between the payment requesting party and the payment responding party, in which the payment requesting party generates transaction information, and the payment responding party is built in with personal information of credit card owners;

receiving the transaction information transmitted from the payment requesting party to the payment responding party through the local wireless connection, and generating a payment request in accordance with the transaction information and the personal information; and

transmitting the payment request to the banking unit releasing payment authentication data through a wireless voice channel, and approving the payment request to complete the payment after the banking unit releasing payment authentication data approves the payment request.

The secure wireless payment system and method thereof allow a consumer to acquire transaction information generated by a payment requesting unit of a seller with a handheld payment responding unit. The payment responding unit has a storage unit embedded with the payment authentication data. After the consumer confirms that the transaction information is correct, a payment request is generated and transmitted to a banking unit that releases the payment authentication data through a secure wireless voice channel so that the banking unit can directly approve to pay for a transaction. However, the payment request is first encrypted and then transmitted to the banking unit, so that the information in the payment request is not stolen during transmitting process. In addition, it is worth mentioning that the use of encryption in the present invention can also ensure the integrity of the messages being exchanged between the payment responding unit and the banking unit. Hence, consumers do not have to present their credit cards, totally getting rid off the risk of credit card piracy. Furthermore, the payment responding unit of the present invention can be automatically connected with the banking unit that releases the payment authentication data, and transmits the payment request having the payment authentication data through the secure wireless voice channel without going through a seller's credit card imprinter or POS machine. Accordingly, the payment authentication data can be securely held by the consumers, the chances of presenting the credit card can be effectively reduced, and the speed of the entire transaction process is significantly accelerated.

Other objectives, advantages and novel features of the invention will become more apparent from the following detailed description when taken in conjunction with the accompanying drawings.

### BRIEF DESCRIPTION OF THE DRAWINGS

FIG. 1 is a system architecture diagram of a secure wireless payment system in accordance with the present invention;

FIG. 2 is a functional block diagram of a payment responding unit of the secure wireless payment system in FIG. 1;

FIG. 3 is a flow diagram of a secure wireless payment method in accordance with the present invention;

FIG. 4A is a timing diagram of an embodiment of the secure wireless payment method in FIG. 3;

FIG. 4B is timing diagram of another embodiment of the secure wireless payment method in FIG. 3;

FIG. 5 is a system architecture diagram of a conventional credit card payment system; and

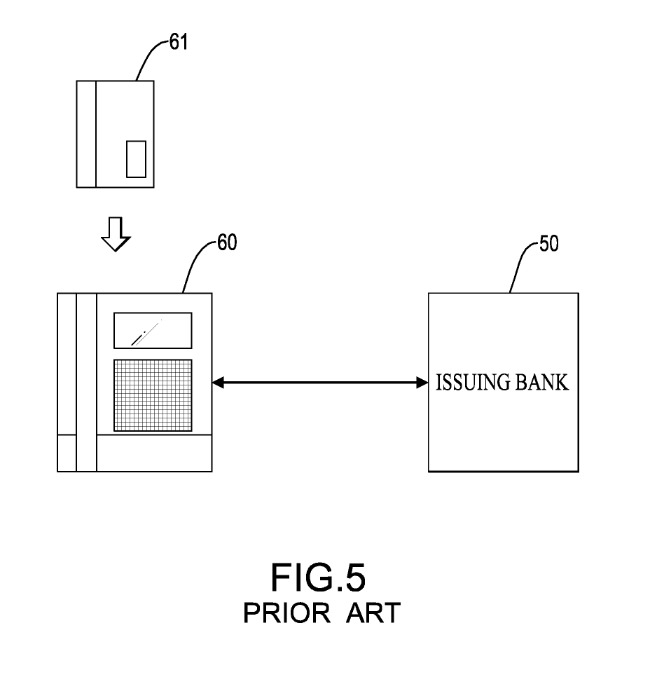

FIG. 6 is a system architecture diagram of a conventional credit card payment system disclosed in U.S. Pat. No. 7,292,996 B2.

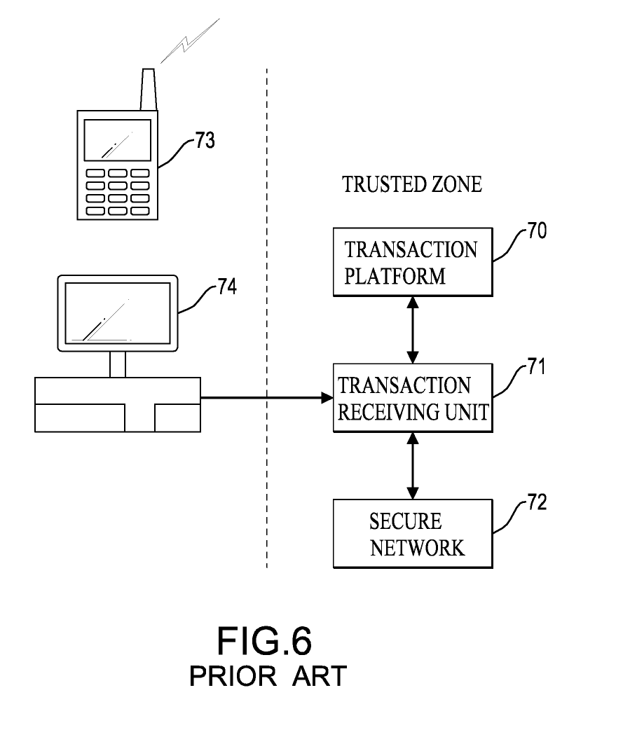

### DETAILED DESCRIPTION OF THE INVENTION

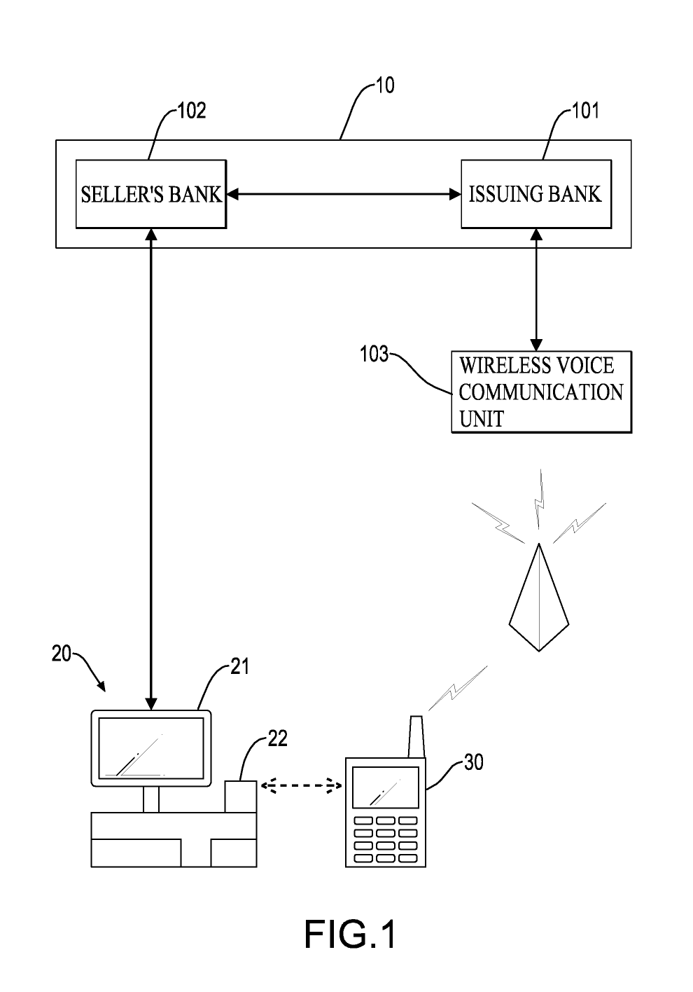

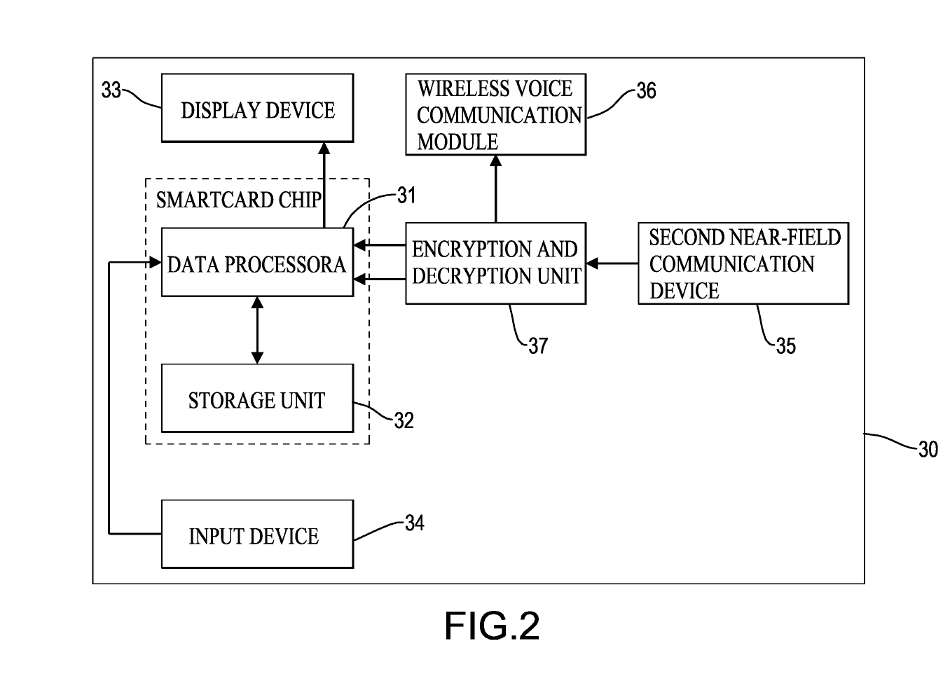

With reference to FIGS. 1 and 2, a secure wireless payment system in accordance with the present invention has a banking unit 10, a payment requesting unit 20 and a payment responding unit 30.

The banking unit 10 has an issuing bank 101 and a seller's bank 102 connected with each other, is connected with a wireless voice communication unit 103, and is stored with payment authentication data, such as personal information of credit card owners. The banking unit 10 employs an OpenSSL encryption technique to transmit and receive data. Each payment authentication datum at least has a credit card number.

The payment requesting unit 20 has a transaction information generation device 21 and a first near-field communication device 22, and is connected with the banking unit 10 through a secure network. The payment requesting unit 20 further has a tamper-resistant packing preventing personnel capable of reaching the payment requesting unit 20 from tampering with circuits and software inside the packing.

The payment responding unit 30 has a data processor 31, a storage unit 32, a second near-field communication device 35, a wireless voice communication module 36, a display device 33, an input device 34 and an encryption and decryption unit 37. The data processor 31 is electrically connected with the storage unit 32, the second near-field communication device 35, the display device 33 and the input device 34. The encryption and decryption unit 37 is connected among the data processor 31, the wireless voice communication module 36 and the second near-field communication device 35. The data processor 31 is locally and wirelessly connected with the first near-field communication device 22 of the payment requesting unit 20 through the second near-field communication device 35 to receive transaction information transmitted from the payment requesting unit 20. The data processor 31 further generates a payment request according to the transaction information and a corresponding payment authentication datum, loads the payment request in a wireless voice channel via the wireless voice communication module 36, and transmits the payment request to the banking unit 10 through the wireless voice communication unit 103 to acquire a payment authorization and complete the transaction. In the present embodiment, the data processor 31 and the storage unit 32 are integrated in a smart card chip. The data processor 31 further has an authentication procedure performed by a PIN mechanism, password mechanism or screen-locking mechanism adopted by HTC™. The payment responding unit further has a tamper-resistant packing preventing the display device from generating erroneous information arising from external circuit or electromagnetic interference and misleading the consumer to willingly pay the amount being incorrect and differing from an actual figure.

The first near-field wireless communication device 22 and the second near-field wireless communication device 35 may be bluetooth transceivers, radio frequency identification (RFID) transceivers, wireless USB transceivers or other components with equivalent functions.

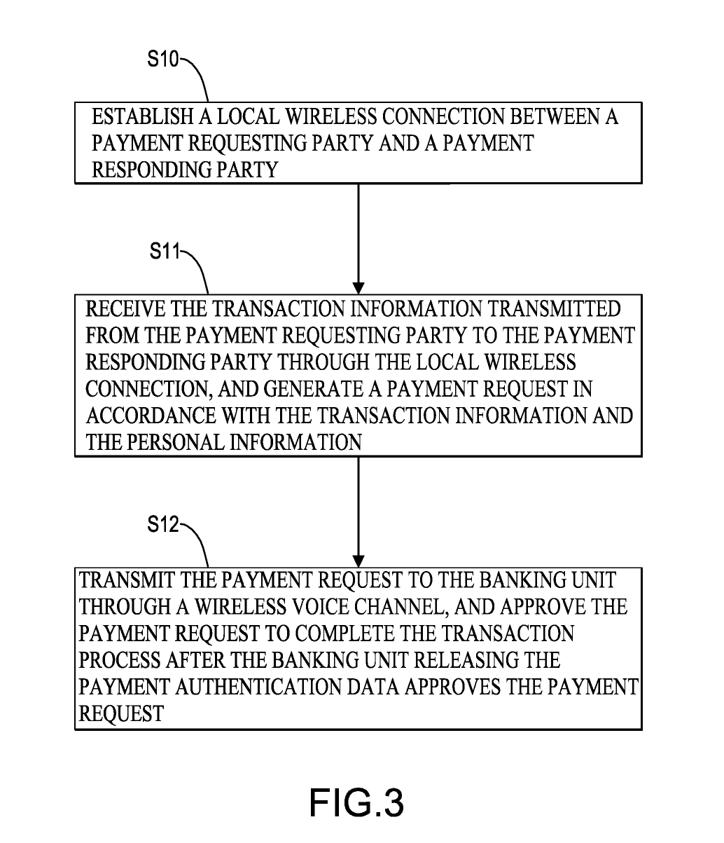

With reference to FIG. 3, a secure wireless payment method in accordance with the present invention has the following steps of:

establishing a local wireless connection between a payment requesting party and a payment responding party S10, in which the payment requesting party generates transaction information, and the payment responding party is built in with payment authentication data released by the banking unit; in the present embodiment, the payment authentication data are personal information of credit card owners and include at least a credit card number;

receiving the transaction information transmitted from the payment requesting party to the payment responding party through the local wireless connection, and generating a payment request in accordance with the transaction information and the personal information S11;

transmitting the payment request to the banking unit 10 through a wireless voice channel, and approving the payment request to complete the transaction process after the banking unit releasing the payment authentication data approves the payment request S12; in the present embodiment, transceiving data through the wireless voice channel is performed by the OpenSSL encryption technique.

The transaction information generated by the payment requesting party is encrypted by a first key and is then transmitted to the payment responding party. After the payment responding party decrypts the transaction information with the stored first key, the transaction information is provided to the consumer for confirmation. After the transaction information is confirmed to be correct, the payment request is generated in accordance with an identification code of the payment requesting party, the transaction information and the payment authentication data, and is transmitted to the banking unit to proceed the transaction process after the payment request is encrypted with a second key.

A secure wireless payment method that is applied to a banking unit 10 having two financial corporations 101, 102 is further described in details as follows.

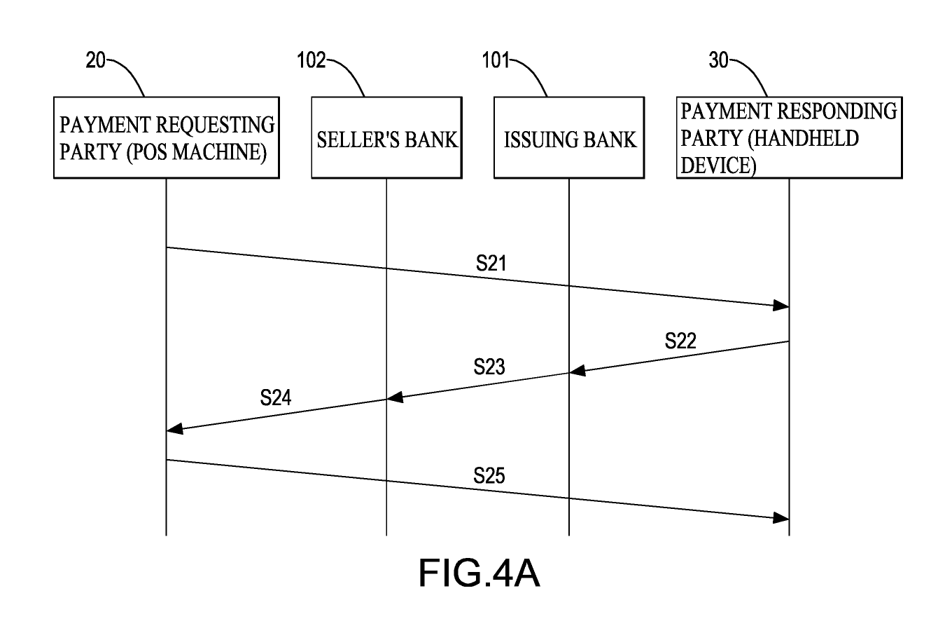

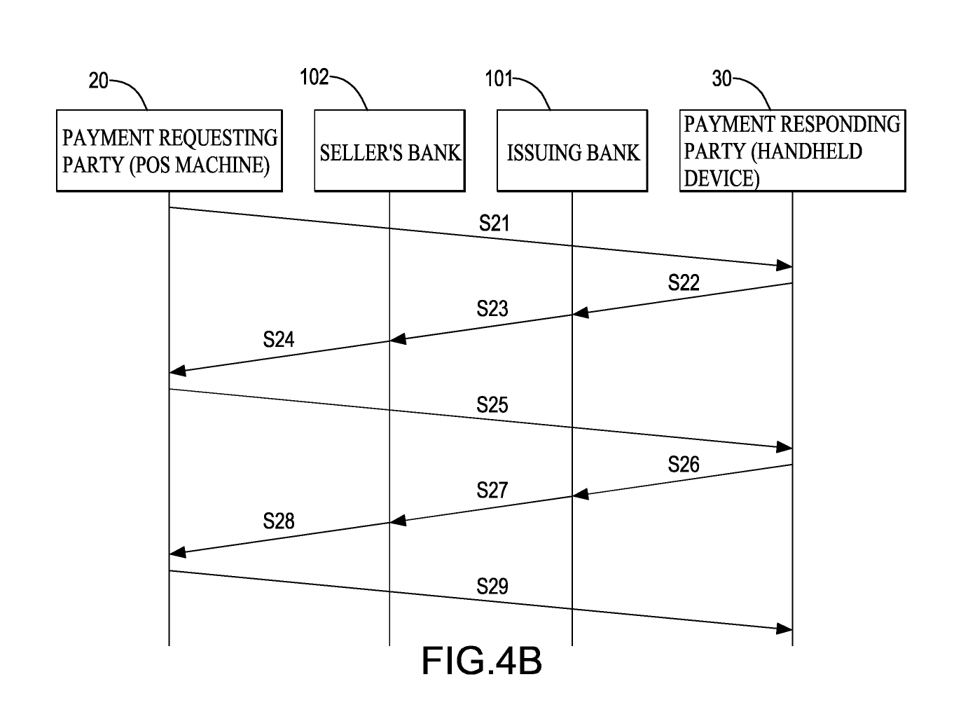

With reference to FIG. 4A, a timing diagram of an embodiment of a secure wireless payment method involving two financial corporations 101, 102 is shown. When a seller operates a payment requesting party (a POS machine) to generate a piece of transaction data (including seller's identification code, seller's bank account number, name of merchandise, payment amount and the like) in accordance with the merchandise purchased by a buyer S21, the buyer establishes a local wireless connection between a payment responding party (a handheld device) and the POS machine to acquire the transaction data encrypted with the first key. After the buyer's handheld device receives the encrypted transaction data through the local wireless connection, the transaction data is decrypted with a previously read first key, and the seller's identification code, name of merchandise, payment amount and the like are read from the transaction data. The name of merchandise and the payment amount are displayed on a display device. After the buyer confirms the displayed information to be correct, the transaction is confirmed through an input device. The handheld device immediately reads the embedded payment identification data (credit card number) and a second key to bundle the seller's identification code, seller's bank account number, name of merchandise, payment amount and credit card number to generate a payment request. After being encrypted by the second key, the payment request is transmitted to a remote first financial corporation (issuing bank) through a wireless voice channel S22. After the buyer's issuing bank connects to the seller's bank in accordance with the seller's bank account number, the buyer's issuing bank informs the seller's bank of a payment request authorization S23. The seller's bank further responds to the seller's POS machine with the payment request authorization S24. The POS machine then generates a request authorization notice and transmits the notice to the handheld device through the local wireless connection. The display device of the handheld device displays the notice to complete the transaction process S25.

With reference to FIG. 4B, a timing diagram of another embodiment of a secure wireless payment method involving two financial corporations 101, 102 is shown. The present embodiment is roughly the same as the embodiment shown in FIG. 4A except that the handheld device further generates an encrypted payment authorization confirmation to the issuing bank S26 to ensure correctness and security of the transaction information when the handheld device receives a payment authorization confirmation notice transmitted from the POS machine. The issuing bank transmits the payment authorization confirmation notice to the seller's bank S27. Similarly, the seller's bank responds to the POS machine with the payment authorization confirmation notice S28. The POS machine informs the handheld device to complete the transaction process S29.

The secure wireless payment method of the present invention allows a consumer to employ a handheld payment responding unit to access the transaction information generated by the seller's payment requesting unit. The payment responding unit has a storage unit embedded with the payment authentication data. After the consumer confirms that the transaction information is correct, a payment request is generated directly and is transmitted to the banking unit releasing the payment authentication data through a secure wireless voice channel so that the banking unit can directly approve the payment. However, the payment request is first encrypted and then transmitted to the banking unit, so that the information in the payment request is not stolen during transmitting process. In addition, it is worth mentioning that the use of encryption in the present invention can also ensure the integrity of the messages being exchanged between the payment responding unit and the banking unit. Accordingly, consumers do not need to pay the transaction by presenting credit cards, thereby eliminating the risk of credit card piracy. Additionally, the payment responding unit of the present invention can automatically connect with the banking unit releasing the payment authentication data, and transmits the payment request having the payment authentication data through the secure wireless voice channel. As the banking unit directly authenticates and approves to pay without going through seller's credit card imprinter or POS machine, the payment authentication data can be effectively held by consumers. Sellers can reduce the chance in charging consumers by swiping credit cards and accelerate the payment process.

Furthermore, as the payment requesting unit and payment responding unit further have the tamper-resistant packing, as far as the payment requesting unit is concerned, the tamper-resistant packing can prevent operators from tampering with circuits and software inside the packing. For example, in a conventional credit card transaction process, the credit card numbers are read out by the credit card reader provided by the store. If a hacker can access the credit card reader, tampering with the hardware is an easy job to do. Consumers are easily under the man-in-the-middle-attacks, such as key logging or tampering of payment request, without knowledge. Hence, when the payment request unit is equipped with the tamper-resistant packing, it is difficult for hackers to log keystrokes and tamper with payment request. The payment responding unit equipped with the tamper-resistant packing serves to prevent another type of tampering that uses external circuit or electromagnetic interference to display erroneous information on consumers' screens, without misleading users to willingly pay the amount being incorrect and differing from an actual figure. Accordingly, the present invention addresses a more secure wireless payment system and method when charging consumers in the transaction process.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A secure wireless payment system, comprising:
a banking unit connected with a wireless voice communication unit, and stored with payment authentication data;
a payment requesting unit having a transaction information generation device and a first near-field communication device, and connected with the banking unit through a secure network; and
a payment responding unit having a data processor, a storage unit, a second near-field communication device and a wireless voice communication module, wherein the data processor is electrically connected with the storage unit and the second near-field communication device, is locally and wirelessly connected with the first near-field communication device of the payment requesting unit through the second near-field communication device to receive transaction information transmitted from the payment requesting unit, generates a payment request according to the transaction information and a corresponding payment authentication datum, loads the payment request in a wireless voice channel via the wireless voice communication module, and transmits the payment request to the banking unit through the wireless voice communication unit to acquire a payment authorization and complete the transaction.

2. The secure wireless payment system as claimed in claim 1, wherein the payment responding unit further has an encryption and decryption unit connected among the data processor, the wireless voice communication module and the second near-field communication device to encrypt the transaction information and load the payment request generated by the data processor in the wireless voice channel via the wireless voice communication module after encrypting the payment request.

3. The secure wireless payment system as claimed in claim 2, wherein the payment requesting unit further has identification codes and a first key embedded therein, the data processor of the payment responding unit has a second key embedded therein, and after acquiring the first key of the payment requesting unit, the data processor decrypts the transaction information encrypted by the first key and encrypts the generated payment request with the second key.

4. The secure wireless payment system as claimed in claim 1, wherein the payment responding unit further has an input device and a display device electrically connected with the data processor, after receiving the transaction information, the data processor displays the transaction information on the display device, and after confirming to receive a transaction confirmation signal transmitted from the input device, the data processor further generates the payment request.

5. The secure wireless payment system as claimed in claim 2, wherein the payment responding unit further has an input device and a display device electrically connected with the data processor, after receiving the transaction information, the data processor displays the transaction information on the display device, and after confirming to receive a transaction confirmation signal transmitted from the input device, the data processor further generates the payment request.

6. The secure wireless payment system as claimed in claim 3, wherein the payment responding unit further has an input device and a display device electrically connected with the data processor, after receiving the transaction information, the data processor displays the transaction information on the display device, and after confirming to receive a transaction confirmation signal transmitted from the input device, the data processor further generates the payment request.

7. The secure wireless payment system as claimed in claim 4, wherein the payment authentication data are personal information of credit card owners and each payment authentication datum at least has a credit card number.

8. The secure wireless payment system as claimed in claim 5, wherein the payment authentication data are personal information of credit card owners and each payment authentication datum at least has a credit card number.

9. The secure wireless payment system as claimed in claim 6, wherein the payment authentication data are personal information of credit card owners and each payment authentication datum at least has a credit card number.

10. The secure wireless payment system as claimed in claim 7, wherein the transaction information has a seller's identification code, a seller's bank account number, a name of merchandise and a payment amount, and the payment request has a seller's identification code, a seller's bank account number, a name of merchandise, a payment amount and a credit card number.

11. The secure wireless payment system as claimed in claim 8, wherein the transaction information has a seller's identification code, a seller's bank account number, a name of merchandise and a payment amount, and the payment request has a seller's identification code, a seller's bank account number, a name of merchandise, a payment amount and a credit card number.

12. The secure wireless payment system as claimed in claim 9, wherein the transaction information has a seller's identification code, a seller's bank account number, a name of merchandise and a payment amount, and the payment request has a seller's identification code, a seller's bank account number, a name of merchandise, a payment amount and a credit card number.

13. The secure wireless payment system as claimed in claim 4, wherein the data processor further has an authentication procedure performed by a PIN mechanism, password mechanism or screen-locking mechanism.

14. The secure wireless payment system as claimed in claim 5, wherein the data processor further has an authentication procedure performed by a PIN mechanism, password mechanism or screen-locking mechanism.

15. The secure wireless payment system as claimed in claim 6, wherein the data processor further has an authentication procedure performed by a PIN mechanism, password mechanism or screen-locking mechanism.

16. The secure wireless payment system as claimed in claim 7, wherein the data processor further has an authentication procedure performed by a PIN mechanism, password mechanism or screen-locking mechanism.

17. The secure wireless payment system as claimed in claim 8, wherein the data processor further has an authentication procedure performed by a PIN mechanism, password mechanism or screen-locking mechanism.

18. The secure wireless payment system as claimed in claim 9, wherein the data processor further has an authentication procedure performed by a PIN mechanism, password mechanism or screen-locking mechanism.

19. The secure wireless payment system as claimed in claim 11, wherein the data processor further has an authentication procedure performed by a PIN mechanism, password mechanism or screen-locking mechanism.

20. The secure wireless payment system as claimed in claim 12, wherein the data processor further has an authentication procedure performed by a PIN mechanism, password mechanism or screen-locking mechanism.

21. The secure wireless payment system as claimed in claim 13, wherein the data processor further has an authentication procedure performed by a PIN mechanism, password mechanism or screen-locking mechanism.

22. The secure wireless payment system as claimed in claim 1, wherein the payment responding unit is a handheld device, and the data processor and the storage unit of the payment responding unit are integrated in a smartcard chip.

23. The secure wireless payment system as claimed in claim 2, wherein the payment responding unit is a handheld device, and the data processor and the storage unit of the payment responding unit are integrated in a smartcard chip.

24. The secure wireless payment system as claimed in claim 3, wherein the payment responding unit is a handheld device, and the data processor and the storage unit of the payment responding unit are integrated in a smartcard chip.

25. The secure wireless payment system as claimed in claim 19, wherein the payment responding unit is a handheld device, and the data processor and the storage unit of the payment responding unit are integrated in a smartcard chip.

26. The secure wireless payment system as claimed in claim 20, wherein the payment responding unit is a handheld device, and the data processor and the storage unit of the payment responding unit are integrated in a smartcard chip.

27. The secure wireless payment system as claimed in claim 21, wherein the payment responding unit is a handheld device, and the data processor and the storage unit of the payment responding unit are integrated in a smartcard chip.

28. The secure wireless payment system as claimed in claim 22, wherein each of the payment requesting unit and the payment responding unit has a tamper-resistant packing.

29. The secure wireless payment system as claimed in claim 23, wherein each of the payment requesting unit and the payment responding unit has a tamper-resistant packing.

30. The secure wireless payment system as claimed in claim 24, wherein each of the payment requesting unit and the payment responding unit has a tamper-resistant packing.

31. The secure wireless payment system as claimed in claim 25, wherein each of the payment requesting unit and the payment responding unit has a tamper-resistant packing.

32. The secure wireless payment system as claimed in claim 26, wherein each of the payment requesting unit and the payment responding unit has a tamper-resistant packing.

33. The secure wireless payment system as claimed in claim 27, wherein each of the payment requesting unit and the payment responding unit has a tamper-resistant packing.

34. The secure wireless payment system as claimed in claim 1, wherein the banking unit employs an OpenSSL encryption technique to transmit and receive data.

35. The secure wireless payment system as claimed in claim 2, wherein the banking unit employs an OpenSSL encryption technique to transmit and receive data.

36. The secure wireless payment system as claimed in claim 3, wherein the banking unit employs an OpenSSL encryption technique to transmit and receive data.

37. The secure wireless payment system as claimed in claim 19, wherein the banking unit employs an OpenSSL encryption technique to transmit and receive data.

39. The secure wireless payment system as claimed in claim 20, wherein the banking unit employs an OpenSSL encryption technique to transmit and receive data.

40. The secure wireless payment system as claimed in claim 21, wherein the banking unit employs an OpenSSL encryption technique to transmit and receive data.

41. The secure wireless payment system as claimed in claim 31, wherein the banking unit employs an OpenSSL encryption technique to transmit and receive data.

42. The secure wireless payment system as claimed in claim 32, wherein the banking unit employs an OpenSSL encryption technique to transmit and receive data.

43. The secure wireless payment system as claimed in claim 33, wherein the banking unit employs an OpenSSL encryption technique to transmit and receive data.

44. The secure wireless payment system as claimed in claim 1, wherein each of the first near-field wireless communication device and the second near-field wireless communication device is a bluetooth transceiver, radio frequency identification transceiver or wireless USB transceiver.

45. The secure wireless payment system as claimed in claim 2, wherein each of the first near-field wireless communication device and the second near-field wireless communication device is a bluetooth transceiver, radio frequency identification transceiver or wireless USB transceiver.

46. The secure wireless payment system as claimed in claim 3, wherein each of the first near-field wireless communication device and the second near-field wireless communication device is a bluetooth transceiver, radio frequency identification transceiver or wireless USB transceiver.

47. A secure wireless payment method executed among a payment requesting party, a payment responding unit and a banking unit, the method comprising steps of:
establishing a local wireless connection between the payment requesting party and the payment responding party, wherein the payment requesting party generates transaction information, and the payment responding party is built in with personal information of credit card owners;
receiving the transaction information transmitted from the payment requesting party to the payment responding party through the local wireless connection, and generating a payment request in accordance with the transaction information and the personal information; and
transmitting the payment request to the banking unit releasing payment authentication data through a wireless voice channel, and approving the payment request to complete the transaction after the banking unit releasing payment authentication data approves the payment request.

48. The secure wireless payment method as claimed in claim 47, wherein after the payment requesting party encrypts the transaction information with a first key, the transaction information is transmitted to the payment responding party, and after the payment responding party encrypts the payment request with a second key, the payment request is transmitted to the banking unit.

49. The secure wireless payment method as claimed in claim 47, wherein a consumer confirms the transaction information before the payment responding party generates the payment request.

50. The secure wireless payment method as claimed in claim 48, wherein a consumer confirms the transaction information before the payment responding party generates the payment request.

51. The secure wireless payment method as claimed in claim 49, wherein the transaction information has a seller's identification code, a seller's bank account number, a name of merchandise and a payment amount, and the payment request has a seller's identification code, a seller's bank account number, a name of merchandise, a payment amount and a credit card number.

52. The secure wireless payment method as claimed in claim 50, wherein the transaction information has a seller's identification code, a seller's bank account number, a name of merchandise and a payment amount, and the payment request has a seller's identification code, a seller's bank account number, a name of merchandise, a payment amount and a credit card number.

53. The secure wireless payment method as claimed in claim 51, wherein the step for the banking unit to approve the payment request further has steps of:
after connecting to a bank of the payment requesting party in accordance with the seller's bank account number, informing the bank of the payment requesting party of a payment request authorization;
responding the payment request authorization from the bank of the payment requesting party to the payment responding party; and
generating a request authorization notice from the payment requesting party and transmitting the notice to the payment responding party through the local wireless connection to inform of a completion of the transaction.

54. The secure wireless payment method as claimed in claim 52, wherein the step for the banking unit to approve the payment request further has steps of:
after connecting to a bank of the payment requesting party in accordance with the seller's bank account number, informing the bank of the payment requesting party of a payment request authorization;
responding the payment request authorization from the bank of the payment requesting party to the payment responding party; and
generating a request authorization notice from the payment requesting party and transmitting the notice to the payment responding party through the local wireless connection to inform of a completion of the transaction.

55. The secure wireless payment method as claimed in claim 51, wherein the step for the banking unit to approve the payment request further has steps of:
after connecting to a bank of the payment requesting party in accordance with the seller's bank account number, informing the bank of the payment requesting party of a payment request authorization;
responding the payment request authorization from the bank of the payment requesting party to the payment responding party;
generating a request authorization notice from the payment requesting party and transmitting the notice to the payment responding party through the local wireless connection;
generating a payment authorization confirmation through the payment responding unit, transmitting the payment authorization confirmation to the banking unit, transmitting a payment authorization confirmation notice from the banking unit to the bank of the payment requesting party, and responding the payment authorization confirmation notice to the payment requesting party; and
reporting from the payment requesting party to the payment responding party to inform of a completion of the transaction.

56. The secure wireless payment method as claimed in claim 52, wherein the step for the banking unit to approve the payment request further has steps of:
after connecting to a bank of the payment requesting party in accordance with the seller's bank account number, informing the bank of the payment requesting party of a payment request authorization;
responding the payment request authorization from the bank of the payment requesting party to the payment responding party;
generating a request authorization notice from the payment requesting party and transmitting the notice to the payment responding party through the local wireless connection;
generating a payment authorization confirmation through the payment responding unit, transmitting the payment authorization confirmation to the banking unit, transmitting a payment authorization confirmation notice from the banking unit to the bank of the payment requesting party, and responding the payment authorization confirmation notice to the payment requesting party; and
reporting from the payment requesting party to the payment responding party to inform of a completion of the transaction.
